(19) United States
(12) Patent Application Publication
(10) Pub. No.: US 2020/0008627 A1
(43) Pub. Date: Jan. 9, 2020

(54) WATER SPRAY MEMBER AND WATER DISCHARGE DEVICE

(71) Applicant: LIXIL Corporation, Tokyo (JP)

(72) Inventor: Shingo MORI, Tokyo (JP)

(73) Assignee: LIXIL Corporation, Tokyo (JP)

(21) Appl. No.: 16/337,826

(22) PCT Filed: Dec. 9, 2017
(86) PCT No.: PCT/JP2017/032751

§ 371 Date: Mar. 28, 2019

(30) Foreign Application Priority Data
Sep. 30, 2016 (JP) 2016192898

(51) Int. Cl. A47K 3/28; B05B 1/18

(52) U.S. Cl. CPC A47K 3/28; E03C 1/066; B05B 1/18

(57) ABSTRACT

With regard to a first rectangle with a minimum area whose four sides circumscribe the shower hole forming surface, the respective dimensions of a first longitudinal side and a first lateral side that are adjacent to each other are denoted as a and b, respectively; and with regard to a second rectangle whose four sides circumscribe the group of points at which the respective central axis lines of the plurality of shower holes pass through the virtual plane and that has a second longitudinal side and a second lateral side, the respective dimensions of the second longitudinal side and the second lateral side are denoted as c and d, respectively, the water spray part is formed such that the following conditions (1) to (3) are satisfied.

a≤b (1)

a/b<c/d (2)

a<c (3)

### CROSS-REFERENCE TO RELATED APPLICATIONS

This application is a national stage application under 35 U.S.C. 371 International Application No. PCT/JP2017/032751, filed Sep. 12, 2017, which claims the priority of Japanese Patent Application No. 2016-192898, filed Sep. 30, 2016, the entire contents of each of which are incorporated herein by reference.

### FIELD OF THE INVENTION

The present invention relates to water spray members used for water discharge devices and to water discharge devices that use the water spray members.

### BACKGROUND OF THE INVENTION

In the related art, various objects have been suggested as water spray members for spraying water in a shower-like form. As an example of this, Patent document 1 discloses a water spray member with a plurality of shower holes arranged in a flat-like shape while having the vertical direction as a longitudinal direction and states that a wide range in the longitudinal direction can become a water spray range of the water spray member.

Patent document 1 Japanese Patent Application Publication No. 2009-235779

### SUMMARY OF THE INVENTION

For water spray members, while there is a demand for widening the water spray range from the viewpoint of usability, there is also a demand for downsizing from the viewpoint of appearance. In the above-mentioned conventional water spray members, it is necessary to secure the dimension in the longitudinal direction of the water spray members in order to widen the water spray range, and there is room for improvement in downsizing of the members.

In this background, a purpose of the present invention is to provide a water spray member suitable for downsizing the member while widening the water spray range.

To solve the problem above, the first embodiment of the present invention relates to a water spray member. The water spray member according to the first embodiment is a water spray member including: a plate-like water spray part through which a plurality of shower holes penetrate in a thickness direction, wherein given that: when a shower hole forming surface on a water spray direction side of the water spray part is viewed in the thickness direction, with regard to a first rectangle with a minimum area whose four sides circumscribe the shower hole forming surface, the respective dimensions of a first longitudinal side and a first lateral side that are adjacent to each other are denoted as a and b, respectively; and on the assumption of a virtual plane that is perpendicular to the thickness direction on the water spray direction side of the water spray part, with regard to a second rectangle whose four sides circumscribe the group of points at which the respective central axis lines of the plurality of shower holes pass through the virtual plane and that has a second longitudinal side and a second lateral side that are respectively parallel to the first longitudinal side and the first lateral side, the respective dimensions of the second longitudinal side and the second lateral side are denoted as c and d, respectively, the water spray part is formed such that the following conditions (1) to (3) are satisfied.

a≤b (1)

a/b<c/d (2)

a<c (3)

According to the water spray member of the first embodiment, even when a shower hole forming surface (a surface on which shower holes are formed) of the water spray member is made small, the water spray range can be widened. Therefore, a water spray member can be provided that is suitable for downsizing the entirety by the downsizing of the shower hole forming surface while widening the water spray range.

### BRIEF DESCRIPTION OF THE DRAWINGS

FIG. 1 is a perspective view showing a water discharge device using a water spray member according to the present embodiment;

FIG. 2 is a plan view of a water discharge device according to the present embodiment;

FIG. 3 is a cross-sectional lateral view of a part of the water discharge device according to the present embodiment;

FIG. 4 is a cross-sectional lateral view showing a water discharge component according to the present embodiment;

FIG. 5 is a diagram showing the relationship between a shower hole forming surface of the water spray member and a water spray intended range according to the present embodiment;

FIG. 6 is a diagram of the shower hole forming surface of the water spray member according to the present embodiment as viewed in the thickness direction;

FIG. 7 is a diagram for explaining the water spray intended range of the water spray member according to the present embodiment;

FIG. 8 is another diagram for explaining the water spray intended range of the water spray member according to the present embodiment;

FIG. 9A is a diagram schematically showing a case of cleaning a container using the water spray member according to the present embodiment; and FIG. 9B is a diagram showing another case of cleaning the container;

FIG. 10 is a diagram showing a water spray range of the water discharge device according to the present embodiment; and

FIG. 11 is another diagram showing the water spray range of the water discharge device according to the present embodiment.

### DETAILED DESCRIPTION OF THE INVENTION

In the following embodiments and exemplary variations, same numerals represent same constituting elements, and duplicative explanations will be omitted. For the sake of ease of explanation, some constituting elements are appropriately omitted, and the dimensions of constituting elements are appropriately enlarged or reduced in the figures.

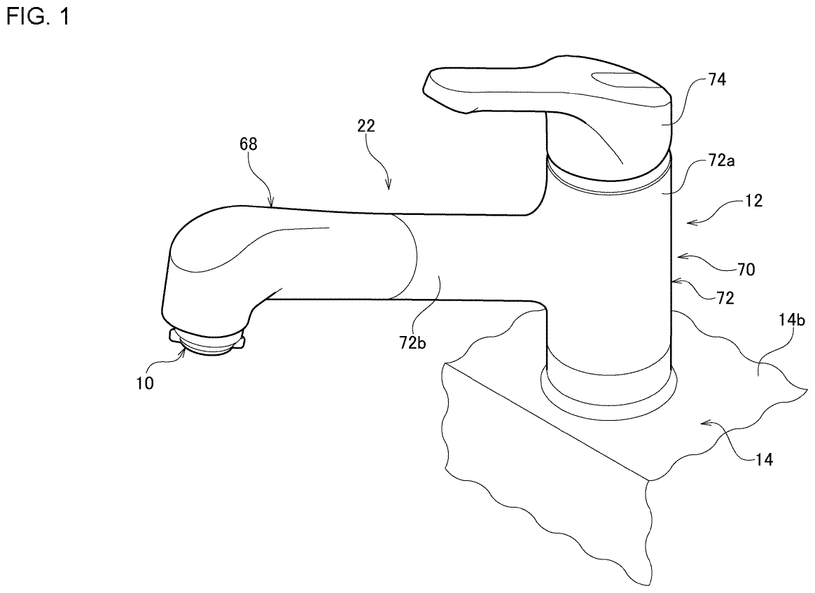

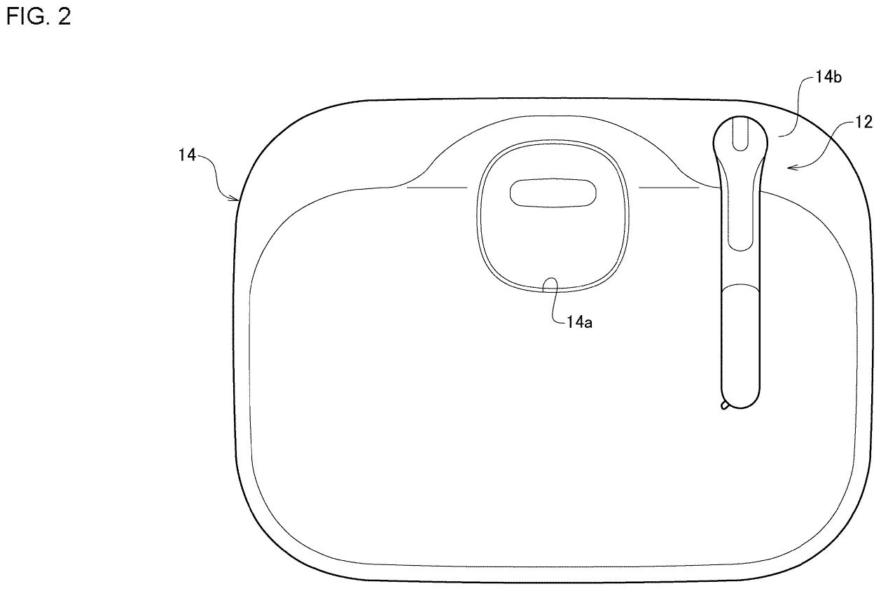

FIG. 1 is a perspective view showing a water discharge device 12 using a water spray member 10 according to the present embodiment. FIG. 2 is a plan view of the water discharge device 12. The water discharge device 12 according to the present embodiment is a faucet device used for a kitchen. The water discharge device 12 according to the present embodiment is used in combination with a water receiving tank 14 such as a sink or the like. The water receiving tank 14 is for receiving a water flow sprayed from the water discharge device 12 and draining water from a drain port 14a. At the periphery of an upper end opening part of the water receiving tank 14, a device fixing part 14b for fixing the water discharge device 12 is provided.

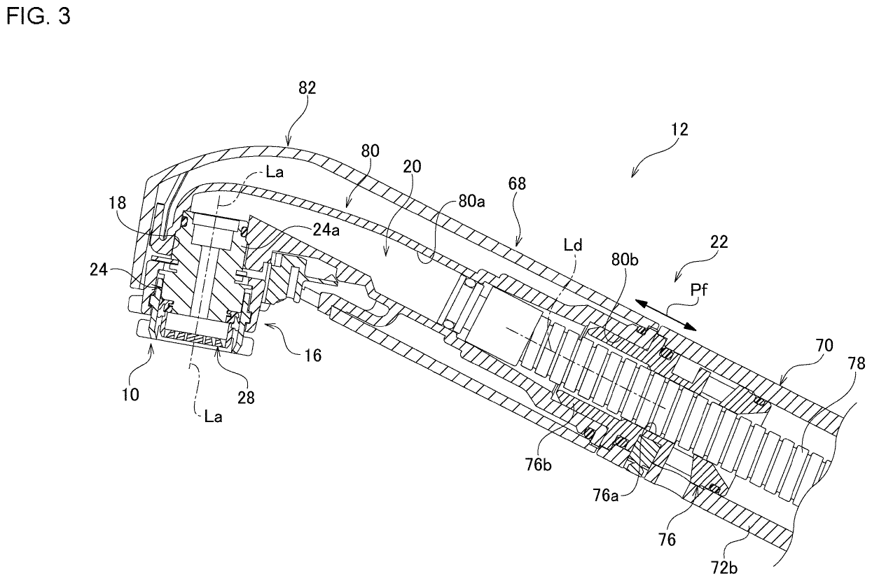

FIG. 3 is a cross-sectional lateral view of a part of the water discharge device 12. The water discharge device 12 has a water discharge component 16 having the water spray member 10 for spraying water in a shower-like form and a device body 22 provided with a mounting hole 18 for mounting the water discharge component 16. A water supply channel 20 for supplying water to the water spray member 10 is provided inside the device body 22. The details of the device body 22 will be described later.

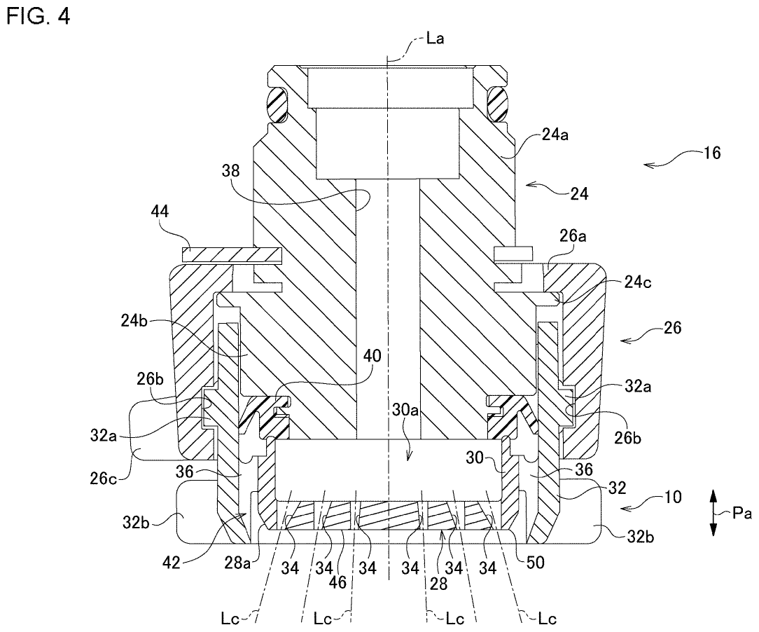

FIG. 4 is a cross-sectional lateral view showing the water discharge component 16. The water discharge component 16 has the water spray member 10, a joint member 24 arranged on the back side of a water spray part 28 (described later) of the water spray member 10, and an outer cylindrical member 26 arranged on the outer circumferential side of the water spray member 10 and the joint member 24.

The water spray member 10 has the water spray part 28, an inner cylindrical part 30, and an outer cylindrical part 32. The water spray part 28 is in a plate-like shape whose front and back are penetrated by a plurality of shower holes 34 in the thickness direction Pa. The inner cylindrical part 30 protrudes from the outer circumferential part of the water spray part 28 toward the back side (the side opposite to the water spray direction). An inflow chamber 30a into which water flows from a water passage hole 38 (described later) of the joint member 24 is formed inside the inner cylindrical part 30. The outer cylindrical part 32 is arranged on the outer circumferential side of the water spray part 28 and the inner cylindrical part 30. The outer cylindrical part 32 is connected to the inner cylindrical part 30 via a plate-like rib part 36 arranged between the water spray part 28 and the inner cylindrical part 30.

The joint member 24 has a cylindrical-like shape as a whole. An upper side portion 24a of the joint member 24 is mounted to the mounting hole 18 of the device body 22 by a screw structure or the like (see also FIG. 3). The joint member 24 is formed with the water passage hole 38 that allows water sent from the water supply channel 20 of the device body 22 to pass through. A lower portion 24b of the joint member 24 is fit inside the outer cylindrical part 32 of the water spray member 10 in a slidable manner.

A seal member 40 is arranged between the lower portion 24b of the joint member 24 and the outer cylindrical part 32 of the water spray member 10. The seal member 40 is fixed to the joint member 24 by adhesion or the like. An end part of the inner cylindrical part 30 of the water spray member 10 located on the back side of the water spray member 10 comes into contact with the seal member 40 such that communication between a space (water discharge hole 42, which is described later) located between the outer cylindrical part 32 and the inner cylindrical part 30 and the water passage hole 38 of the joint member 24 is interrupted.

The outer cylindrical member 26 has a cylindrical-like shape as a whole. The outer cylindrical member 26 is provided with an inner step part 26a protruding inward at an upper end part thereof. An outer step part 24c protrudes outward is provided at the outer circumferential part of the joint member 24. Due to the inner step part 26a coming into contact with the outer step part 24c of the joint member 24, a relative downward displacement of the outer cylindrical member 26 with respect to the joint member 24 is restricted. A retaining ring 44 is installed on the outer circumferential part of the joint member 24 above the outer step part 24c. Due to the outer cylindrical member 26 coming into contact with the retaining ring 44, a relative upward displacement of the outer cylindrical member 26 with respect to the joint member 24 is restricted. Thereby, while being in a state where a relative displacement of the outer cylindrical member 26 in the thickness direction Pa of the water spray part 28 with respect to the joint member 24 is restricted, the outer cylindrical member 26 is rotatably supported around a direction axis La (hereinafter simply referred to as thickness direction axis La) of the thickness direction Pa.

Two spiral grooves 26b are formed on the inner circumferential surface of the outer cylindrical member 26, and a convex part 32a which comes slidably comes into contact with the spiral grooves 26b is formed on the outer circumferential surface of the outer cylindrical part 32 of the water spray member 10. The water spray member 10 is supported by the joint member 24 via the outer cylindrical member 26 by the contact of the convex part 32a with the spiral grooves 26b of the outer cylindrical member 26. The water spray member 10 is supported rotatably around the thickness direction axis La together with the outer cylindrical member 26 with respect to the joint member 24.

With the above configuration, when water is sent from a water supply source to the water supply channel 20 of the device body 22, water is supplied to the water discharge component 16. When water is supplied to the water discharge component 16, water flows into the inflow chamber 30a of the water spray member 10 through the water passage hole 38 of the joint member 24 and is sprayed downward through the plurality of shower holes 34.

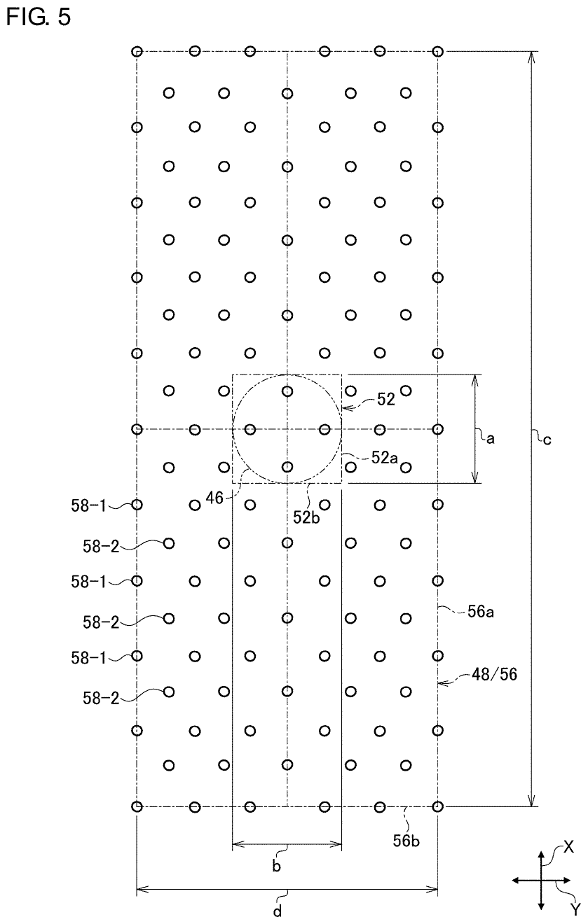

FIG. 5 is a diagram showing the relationship between the shower hole forming surface 46 of the water spray member 10 and a water spray intended range 48. The water spray member 10 according to the present embodiment is characterized by this relationship. A detail description thereof is given in the following.

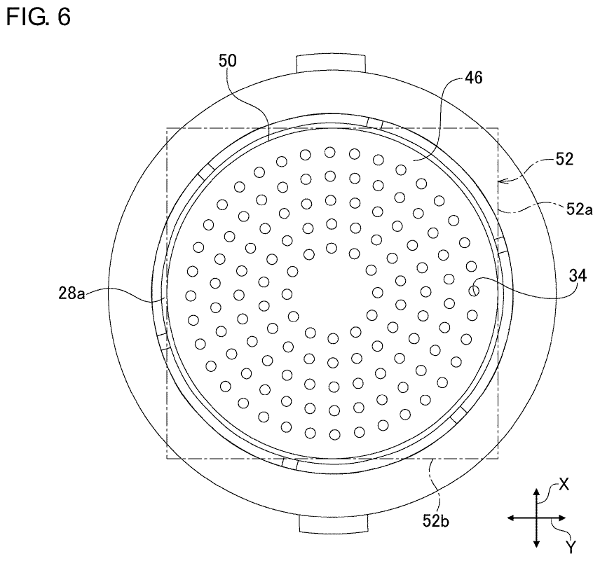

FIG. 6 is a diagram of the shower hole forming surface 46 of the water spray member 10 as viewed in the thickness direction Pa. As shown in FIGS. 4 and 6, this shower hole forming surface 46 is a surface region in which the plurality of shower holes 34 located on the water spray direction side (front side) of the water spray part 28 are formed, and is a surface region whose outer edge line 50 forms a closed line shape. This outer edge line 50 is provided so that all the shower holes 34 are arranged inside the outer edge line 50 and serves as a boundary line between an outer circumferential surface 28a of the water spray part 28 surrounding the thickness direction axis La of the water spray part 28 and the shower hole forming surface 46. The planar shape of this shower hole forming surface 46 is based on a view where the shower hole forming surface 46 is viewed in the thickness direction Pa. The thickness direction Pa is also a direction in which the projected area of the shower hole forming surface 46 to a plane orthogonal to the direction is maximized. In the present embodiment, the plurality of shower holes 34 are arranged in the form of a multiple (five-fold) concentric circle-like shape on this shower hole forming surface 46.

As shown in FIG. 6, in the present embodiment, a first rectangle 52 with a minimum area whose four sides circumscribe the shower hole forming surface 46 is used as an index indicating the size of the planar shape of the shower hole forming surface 46. This first rectangle 52 has a first longitudinal side 52a and a first lateral side 52b, which are adjacent to each other. Regarding this first rectangle 52, as shown in FIG. 5, the respective lengths of the first longitudinal side 52a and the first lateral side 52b are referred to as a longitudinal dimension a and a lateral dimension b, respectively. Hereinafter, the direction along the first longitudinal side 52a is referred to as a longitudinal direction X, and the direction along the first lateral side 52b is referred to as a lateral direction Y.

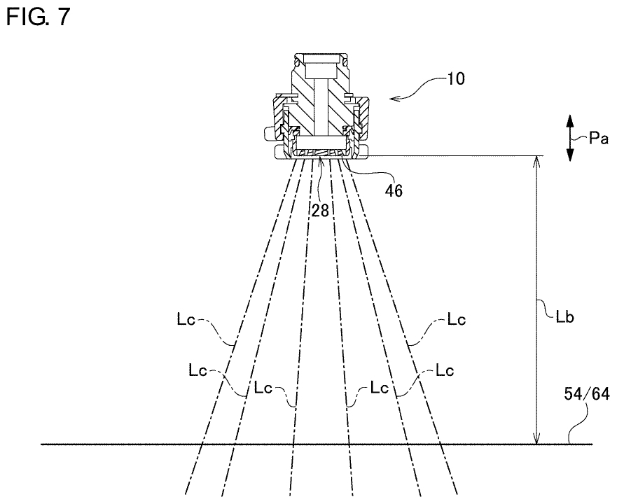

FIG. 7 is a diagram for explaining the water spray intended range 48 of the water spray member 10. This figure is also a diagram showing a cross section of the water spray member 10 cut along the thickness direction Pa. In the present embodiment, in order to define an index indicating the size of the water spray range of the water spray member 10, a first virtual plane 54 located at a predetermined position is assumed. This first virtual plane 54 is a plane orthogonal to the thickness direction Pa on the water spray direction side (front side) of the water spray part 28. This first virtual plane 54 is located at a predetermined distance Lb from the shower hole forming surface 46 in the thickness direction Pa, specifically, 15 cm away from the shower hole forming surface 46.

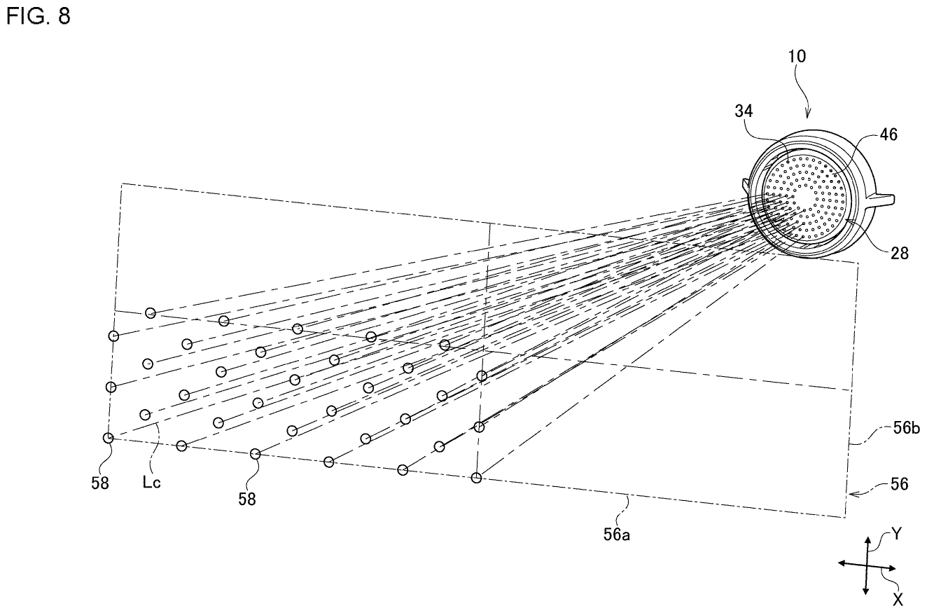

FIG. 8 is another diagram for explaining the water spray intended range 48 of the water spray member 10. In the present embodiment, a second rectangle 56 drawn on the above-described first virtual plane 54 is used as an index indicating the size of the water spray range of the water spray member 10. In the second rectangle 56, the four sides thereof circumscribe the group of passing points 58 at which the respective central axis lines Lc of the plurality of shower holes 34 pass through the first virtual plane 54. In this figure, for convenience of explanation, the passing points 58 are shown in a circle-like shape having a fixed size. However, in reality, the passing points 58 are each located at the center of gravity position of the circle. Also, in this figure, only a part of the group of the passing points 58 is shown. The arrangement pattern of the group of the passing points 58 is different from the arrangement pattern of the shower holes 34 formed on the shower hole forming surface 46.

As shown in FIGS. 5 and 8, the second rectangle 56 has a second longitudinal side 56a and a second lateral side 56b parallel to the first longitudinal side 52a and the first lateral side 52b of the first rectangle 52, respectively. The second rectangle 56 shows a range (hereinafter referred to as a water spray intended range 48) through which a group of water flows that is sprayed from a plurality of shower holes 34 passes under a condition where there is no influence of gravity, and is used as an index indicating the size of the actual water spray range. Regarding this second rectangle 56, the respective lengths of the second longitudinal side 56a and the second lateral side 56b are referred to as a longitudinal dimension c and a lateral dimension d, respectively.

The water spray part 28 of the water spray member 10 is formed so as to satisfy the following conditions (1) to (3). The condition (1) means that the longitudinal dimension a and the lateral dimension b formed by the planar shape of the shower hole forming surface 46 are the same or the longitudinal dimension a is larger than the lateral dimension b. In the present embodiment, an example is shown in which the longitudinal dimension a and the lateral dimension b are the same. The condition (2) means that the aspect ratio (the ratio of the longitudinal dimension to the lateral dimension) of the water spray intended range 48 of the water spray part 28 becomes larger than the aspect ratio of the planar shape of the shower hole forming surface 46. The condition (3) means that the water spray intended range 48 of the water spray part 28 spreads wider at least in the longitudinal direction X than the range of the planar shape of the shower hole forming surface 46.

a≤b (1)

a/b<c/d (2)

a<c (3)

If such conditions (1) to (3) are satisfied, even when the planar shape of the shower hole forming surface 46 of the water spray member 10 is made small, the water spray intended range 48 of the water spray part 28 can be widened in the longitudinal direction X, and the actual water spray range can be also widened in the longitudinal direction X. Therefore, the water spray member 10 can be provided that is suitable for downsizing the entirety by downsizing the planar shape of shower hole forming surface 46 of the water spray member 10 while widening the water spray range. Further, since the entire water spray member 10 can be downsized, the field of view is less likely to be blocked by the water spray member 10, and favorable user-friendliness can thus be obtained. Further, in the case of use in combination with a water receiving tank 14 as in the present embodiment, the widening of the water spray range allows dishes and the like to be washed easily, and favorable user-friendliness can be obtained also in that point.

In addition, while widening the water spray intended range 48 of the water spray part 28 in the longitudinal direction X, spreading of the water spray intended range 48 largely in the lateral direction Y can be suppressed, and the water flow density in the actual water spray range in the lateral direction Y can be maintained adequately. Therefore, while widening the water spray range of the water spray part 28 in the longitudinal direction X, adequate cleaning performance can be obtained by suppressing uneven cleaning in the lateral direction Y of the water spray range, and favorable user-friendliness can be obtained also in that point.

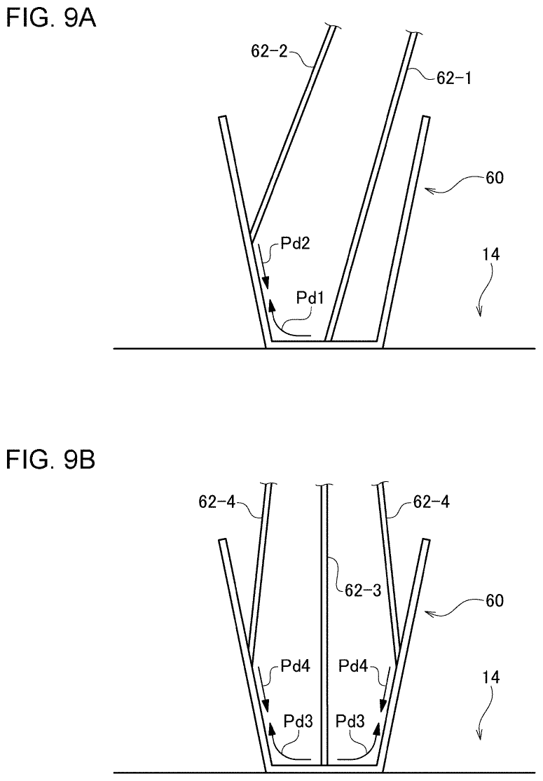

Further, as will be explained below, there is also an effect of being able to prevent the occurrence of water splash at the time of cleaning the container. FIG. 9A is a diagram schematically showing a case of cleaning a container 60 placed at the bottom surface part of the water receiving tank 14. In the water spray member 10 satisfying the above-described conditions, it is easy to vary the angle of a water flow 62 sprayed from each of the plurality of shower holes 34. Therefore, it is easy to realize a situation where, while a water flow 62-1 is hitting the bottom surface of the container 60, another water flow 62-2 located on the traveling direction side of the water flow 62-1 on a horizontal plane hits an inner side surface of the container 60. Under this situation, even when the water flow 62-1 that has hit the bottom surface of the container is about to form a flow Pd1 travelling upward on the inner side surface of the container 60, the force of the flow Pd1 is lost due to collision with a flow Pd2 formed by a water flow hitting the inner side surface of the container 60. As a result, water splashing from the container 60 is less likely to occur.

FIG. 9B is a diagram showing an example where a water flow 62-3 flowing substantially vertically downward is included in the water flow group sprayed from the water spray member 10. In this case, in the water spray member 10 described above, it is easy to set a situation where there are water flows 62-4 flowing in different directions on the horizontal surface on both sides of the water flow 62-3 flowing vertically downward. Therefore, it is easy to set a situation where, while a water flow is applied to the bottom surface of the container 60, the other water flows 62-4 are applied to different parts of the inner side surface that sandwich the central axis line of the container 60. Under this situation, even when the water flow 62-1 that has hit the bottom surface of the container 60 is about to form a flow Pd3 travelling upward on the inner side surface of the container 60, the force of the flow Pd3 is lost due to collision with a flow Pd4 formed by a water flow hitting the inner side surface of the container 60. As a result, water splashing from the container 60 is less likely to occur.

FIG. 5 is referred back. From the viewpoint of downsizing the planar shape of the shower hole forming surface 46 while increasing the water spray range, the larger the longitudinal dimension c of the water spray intended range 48 than the longitudinal dimension a of the shower hole forming surface 46, it is better. From this viewpoint, with respect to the above-mentioned condition (3), the longitudinal dimension c of the water spray intended range is preferably a times two or more and more preferably a times three or more. The maximum value of c is not particularly limited and may be, for example, a times eight or less. These are set on the premise that the above-mentioned distance Lb is 15 cm.

From the viewpoint of appropriately maintaining the water flow density in the horizontal direction Y of the water spray range while expanding the water spray range in the longitudinal direction X, the aspect ratio of the water spray intended range 48 can be preferably made to be larger than the aspect ratio of the planar shape of the shower hole forming surface 46 to some extent while satisfying the conditions described in the previous paragraphs. From this viewpoint, with respect to the above-mentioned condition (2), c/d is preferably (a/b) times two or more and more preferably (a/b) times three or more. The maximum value of c/d is not particularly limited and may be, for example, (a/b) times eight or less. These are set on the premise that the above-mentioned distance Lb is 15 cm.

The above-mentioned condition (1) will be described later. Although the example have been explained where the lateral dimension d of the water spray intended range 48 is larger than the lateral dimension b of the shower hole forming surface 46, the relationship therebetween is not particularly limited. For example, the lateral dimension d of the water spray intended range 48 may be the same as the lateral dimension b of the shower hole forming surface 46 or may be smaller than the lateral dimension b of the shower hole forming surface 46.

FIG. 5 shows an example of an arrangement pattern in which the group of the passing points 58 passing over the first virtual plane 54 is dispersed in a rectangular-like region. This arrangement pattern is not particularly limited as long as the above-mentioned conditions (1) to (3) are satisfied, and the group may be dispersed in a range of, for example, a rhombic-like shape, an elliptical-like shape, or the like.

Further, in FIG. 6, an example has been described in which the planar shape of the shower hole forming surface 46 is a circle-like shape; however, the planar shape may be an elliptical-like shape, a regular polygonal-like shape, or the like. The term “-like” in the present specification includes not only a geometrically exact match with the shape indicated by the immediately preceding term but also a shape similar to that indicated by the preceding term.

Next, other features of the water spray member 10 will be explained. Referring to FIG. 7, a second virtual plane 64 perpendicular to the thickness direction Pa described above is assumed. For the second virtual plane 64 used here, the same plane used for the first virtual plane 54 is used for an example for explanation; however, a different plane may be used. FIG. 5 is a diagram that also shows passing points 58 through which the center axis line of each of the plurality of shower holes 34 passes on the second virtual plane 64.

On the second virtual plane 64, the water spray part 28 is formed such that the passing points 58 are arranged in rows in the longitudinal direction X of the second rectangle 56 and a plurality of rows of the passing points 58 are arranged side by side in the lateral direction Y of the second rectangle 56. On the second virtual plane 64, the water spray part 28 is formed such that passing points 58 in a row and passing points 58 in an adjacent row in the lateral direction Y are shifted from each other in the longitudinal direction X of the second rectangle 56. For example, passing points 58-1 on the leftmost column in FIG. 5 and passing points 58-2 in the adjacent column in the lateral direction Y are shifted from each other in the longitudinal direction Y. In the present embodiment, the water spray part 28 is formed such that passing points 58 in the first row arranged alternately in the lateral direction Y of the second rectangle 56 and passing points 58 in the second row arranged between those in the first row are arranged alternately in the lateral direction Y toward the longitudinal direction X of the second rectangle 56. This allows the water flow distribution of the water flow group sprayed from the water spray part 28 to be easily made uniform by suppressing unevenness in the longitudinal direction X in the water flow distribution, and, by suppressing uneven cleaning, favorable cleaning performance can be obtained.

FIG. 4 is referred back. Each of the plurality of shower holes 34 is formed so as to discharge a single line-like water flow. This means that each of the plurality of shower holes 34 does not discharge a water flow that spreads in a spray-like manner. In order to realize this, the shower holes 34 according to the present embodiment have a tapered-like shape in which the inner diameter decreases toward the outlet side from the inlet side. Other than this, the shower holes 34 may have a straight-like shape having an equal inner diameter from the inlet side toward the outlet side. These conditions need to be satisfied at least by the respective outlet side portions of the shower holes 34. Thereby, even when a water flow group sprayed from the water spray part 28 of the water spray member 10 hits the surface of an object such as a user, dishware, or the like, splashing is less likely to occur, and even more favorable user-friendliness can be obtained.

Next, other features of the water discharge device 12 according to the present embodiment will be explained. FIG. 3 is referred back. As described above, the water spray member 10 according to the present embodiment is supported rotatably around the thickness direction axis La with respect to the joint member 24. From another viewpoint, it can be considered that the water spray member 10 is mounted in the device body 22 via the joint member 24 and is mounted rotatably around the thickness direction axis La with respect to the device body 22. This thickness direction axis La is an axis passing through the front and back of the water spray part 28 of the water spray member 10.

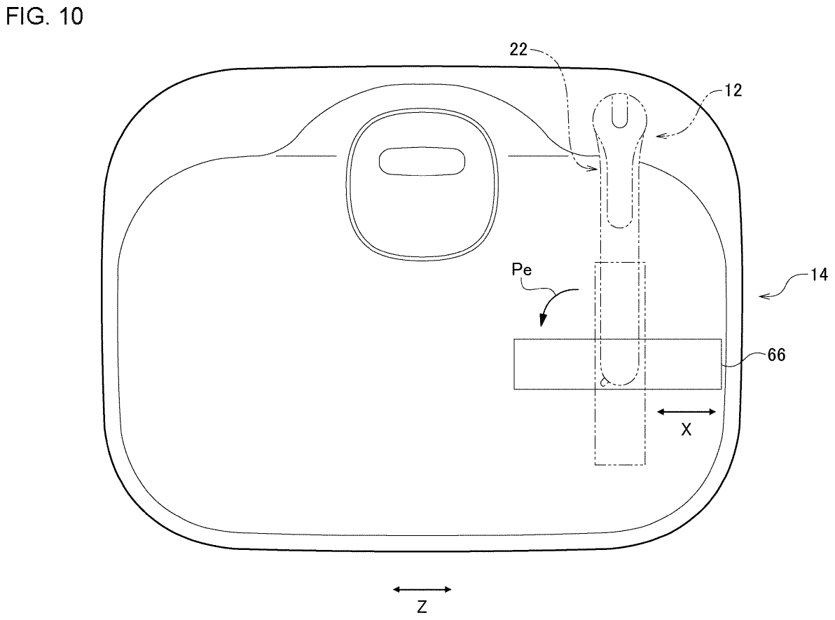

FIG. 10 is a diagram showing a water spray range 66 of the water discharge device 12. According to the above configuration, by rotating the water spray part 28 around the axis in the thickness direction Pa, the water spray range 66 of the water spray part 28 can be rotated in a direction Pe around the thickness direction axis La without changing the direction of the device body 22. Therefore, favorable user-friendliness can be obtained by changing the water spray range 66 of the water spray part 28 according to the user's preference or circumstances (shape of the object to be cleaned, etc.). The favorable user-friendliness used here means, for example, the following. A direction in which the water receiving tank 14 extends laterally as viewed from the front is referred to as a lateral direction Z. At this time, when the dishes are washed under a situation where the longitudinal direction X of the water spray range 66 (water spray intended range) of the water spray part 28 is brought close to the lateral direction Z of the water receiving tank 14, it becomes difficult for water to reach the user located on the front side of the water receiving tank 14. In this respect, the favorable user-friendliness can be obtained.

Further, since the water spray member 10 is rotated around the thickness direction axis La penetrating the front and back of the water spray part 28, the size of a trajectory traced by the water spray member 10 during the rotation can be made compact. Further, as described above, there is no need to change the orientation of the device body 22 in order to rotate the water spray range 66 of the water spray part 28. In combination with these, it is possible to prevent interference of the water spray member 10 and the device body 22 with the surrounding objects in rotating the water spray range 66, and it is also possible to prevent the visibility from being blocked due to the change in the orientation. Thus, favorable user-friendliness can be obtained. Further, in rotating the water spray range 66, the apparent size of operating parts can be reduced, and a good appearance can be obtained by giving a clear impression.

In order to allow the size of the trajectory traced by the water spray member 10 during rotation to be made compact easily, with respect to the above condition (1), the closer the longitudinal dimension a of the shower hole forming surface 46 is to the lateral dimension b, it is better. Therefore, the longitudinal dimension a is preferably b times 1.5 or less and more preferably b times 1.3 or less.

Further, as shown in FIG. 4, the outer cylindrical member 26 is provided with a first knob part 26c projecting outward in the radial direction, and the water spray member 10 is provided with a second knob part 32b projecting outward in the radial direction from the outer cylindrical part 32. Each of the knob parts 26c and 32b is for an operation of rotating the outer cylindrical member 26 and the water spray member 10.

Next, the device body 22 of the water discharge device 12 will be explained. As shown in FIGS. 1 and 3, the device body 22 has a water discharge head 68 on which the water discharge component 16 is mounted and a head holder 70 for detachably holding the water discharge head 68.

As shown in FIG. 1, the head holder 70 is fixed to the device fixing part 14b of the water receiving tank 14. The head holder 70 according to the present embodiment has a housing 72 in which a shell pipe 72a and a branch pipe 72b projecting from the shell pipe 72a are formed and a lever 74 mounted at a distal end part of the shell pipe 72a. The lever 74 is a so-called single lever capable of adjusting the temperature and the flow rate of water sprayed from the water spray member 10 through the operation of a valve unit (not shown) arranged inside the housing 72.

As shown in FIG. 3, the head holder 70 further has a hose guide 76 mounted at a distal end part of the branch pipe 72b. The hose guide 76 has a hose insertion hole 76a through which a water supply hose 78, which is to be connected to the water discharge head 68, is inserted and which guides the water supply hose 78 in such a manner that the water supply hose 78 can be inserted and removed and has a cylindrical head guide part 76b projecting in a direction in which the water supply hose 78 is pulled out with respect to the hose insertion hole 76a. The water supply hose 78 has flexibility, and a part of the above-described water supply channel 20 is provided inside thereof. The water supply hose 78 is supplied with water from a water supply source through the valve unit (not shown) inside the housing 72.

The water discharge head 68 has a head body 80 provided with an internal passage 80a, which becomes a part of the water supply channel 20 described above, and a head cover 82 covering the head body 80. A distal end part of the water supply hose 78 is connected to the upstream end part of the internal passage 80a of the head body 80. A mounting hole 18 for mounting the water discharge component 16 is formed at the downstream end part of the internal passage 80a of the head body 80.

A guided part 80b is provided in the internal passage 80a of the head body 80 on the upstream end side of the connection part of the water supply hose 78. The head guide part 76b of the hose guide 76 is fit inside the guided part 80b of the water discharge head 68. Thereby, the position of the water discharge head 68 with respect to the head holder 70 in a direction perpendicular to an axial direction Pf of the hose insertion hole 76a of the head holder 70 is held. The water discharge head 68 can be attached to and detached from the head holder 70 by moving the water discharge head 68 in the axial direction Pf of the hose insertion hole 76a of the head holder 70. The head guide part 76b of the hose guide 76 plays a role of guiding the water discharge head 68 in the attachment/detachment direction Pf (the axial direction of the hose insertion hole 76a) by the sliding of the guided part 80b of the water discharge head 68 when the water discharge head 68 is attached to and detached from the head holder 70.

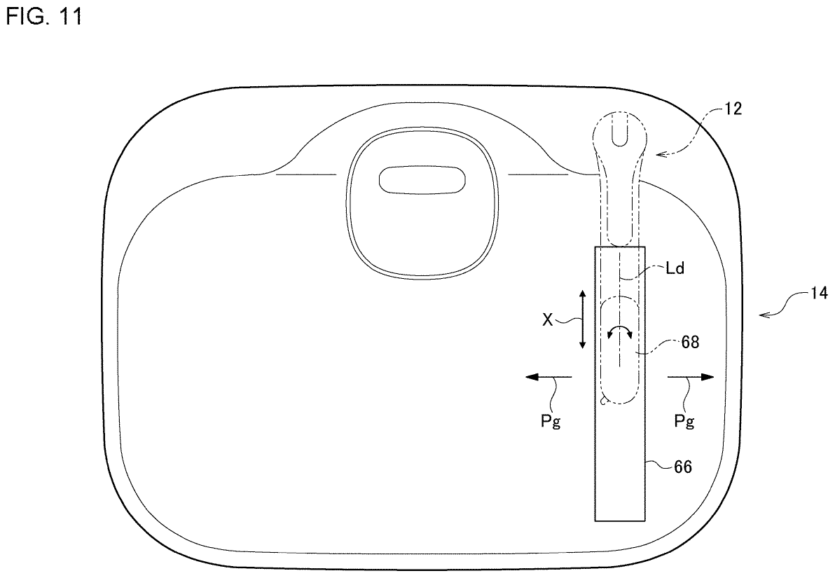

The guided part 80b of the water discharge head 68 is held rotatably around the attachment/detachment direction axis Ld along the attachment/detachment direction Pf of the water discharge head 68 with respect to the head holder 70. Thereby, as shown in FIG. 11, by rotating the water discharge head 68 around the attachment/detachment direction axis Ld, the water spray range 66 of the water spray member 10 can be moved in a direction Pg in a sweeping-like manner. Thereby, by washing away foreign objects such as vegetable waste, detergent foam, etc., inside the water receiving tank 14 in a sweeping-like manner, the foreign objects can be more easily collected quickly, and more favorable user-friendliness can be obtained. In particular, in a plan view, the rotational position around the thickness direction axis La of the water spray member 10 is preferably adjusted such that the longitudinal direction X of the water spray range 66 (water spray intended range 48) becomes closer to the attachment/detachment direction axis Ld of the water discharge head 68. Thereby, when the water discharge head 68 is rotated around the attachment/detachment direction axis Ld, the water spray range 66 of the water spray member 10 can be moved within a wide range, and foreign objects in the water receiving tank 14 can be more effectively washed away easily in a sweeping-like manner.

The water spray member 10 is also characterized in the following points. FIG. 4 is referred back. A water discharge hole 42 for straight water discharging is formed between the outer cylindrical part 32 and the inner cylindrical part 30 of the water spray member 10. The water discharge hole 42 is provided so as to surround the plurality of shower holes 34 of the water spray part 28. When the water spray member 10 is rotated while the rotation of the outer cylindrical member 26 is being restrained, the convex part 32a of the water spray member 10 slides along the spiral grooves 26b of the outer cylindrical member 26, thereby moving the water spray member 10 relatively with respect to the outer cylindrical member 26 in the thickness direction Pa. At this time, the water spray member 10 moves relatively in the thickness direction Pa while approaching to or being separated from the joint member 24.

When the water spray member 10 approaches to the joint member 24 in the thickness direction Pa, the outer cylindrical part 32 of the water spray member 10 comes into contact with the seal member 40, and the communication between the water passage hole 38 of the joint member 24 and the water discharge hole 42 for straight water discharging is disconnected (the state of FIG. 4). At this time, as described above, when water flows into the back side of the water spray part 28 of the water spray member 10, the water is not guided to the water discharge hole 42 for straight water discharging but is guided only to the plurality of shower holes 34, and the water is sprayed downward in a shower-like manner through the plurality of shower holes 34.

On the other hand, although not shown, when the water spray member 10 is separated from the joint member 24 in the thickness direction Pa, the outer cylindrical part 32 of the water spray member 10 becomes separated from the seal member 40, and the water passage hole 38 of the joint member 24 and the water discharge hole 42 for straight water discharging are thereby communicated with each other. At this time, when water flows into the back side of the water spray part 28 of the water spray member 10, the water is guided to both of the plurality of shower holes 34 and the water discharge hole 42 for straight water discharging and is discharged through each of them. A water flow discharged from the plurality of shower holes 34 and a water flow discharged from the water discharge hole 42 for straight water discharging are integrated to form a straight water discharge flow in which water sent from the water supply source is discharged without change.

Exemplary embodiments of the present invention have been explained above in detail. All the above-described embodiments merely show specific examples for carrying out the present invention. The details of the embodiments do not limit the technical scope of the present invention, and many design modifications such as change, addition, deletion, etc., of the constituent elements may be made without departing from the spirit of the invention defined in the claims. In the above-described embodiments, an explanation has been made with the notations “according to the embodiment”, “in the embodiment”, etc., for the details for which such design change is possible. However, it does not mean that design change is not allowed for those without such notations. Further, hatching applied to a cross section of a drawing does not limit the material of an object to which the hatching is applied.

For the water discharge device 12, an example has been explained where the water discharge device 12 is used for a kitchen. However, the water discharge device 12 may be used for a wash basin, a washbowl, a bathroom, and the like. In the case where the water discharge device 12 is used for a wash basin or washbowl, the water receiving tank 14 is constituted of a bowl. An example has been explained where the device fixing part 14b of the water discharge device 12 is provided in the water receiving tank 14. However, the present invention is not limited thereto, and a back guard or the like of a washstand may be used.

In the device body 22 of the water discharge device 12, the water discharge component 16 needs to be mounted, and the water supply channel 20 for supplying water to the water discharge component 16 needs to be provided inside. An example has been explained where the device body 22 has the water discharge head 68 and the head holder 70 as an example that satisfies this condition. However, this is non-limiting. For example, the device body 22 may have a spout of a gooseneck-like shape or the like, and the water discharge component 16 may be mounted at the distal end part thereof. Also, as long as the head holder 70 has functions of the hose insertion hole 76a and the head guide part 76b of the hose guide 76, the concrete structure thereof is not limited to the illustrated example.

An example has been explained where the water spray member 10 is mounted rotatably around the thickness direction axis La with respect to the device body 22 of the water discharge device 12. As long as this rotation axis passes through the front and back of the water spray part 28 of the water spray member 10, and the rotation axis is not limited to the thickness direction axis La.

The following technical ideas are derived by generalizing the invention embodied according to the above embodiments and exemplary variations. Hereinafter, explanation will be made using the aspects described in the problem to be solved by the invention.

In a water spray member according to the second aspect, on the assumption of a virtual plane that is perpendicular to the thickness direction, the plurality of shower holes may be formed such that a plurality of rows of points at which the respective central axis lines of the plurality of shower holes pass through the virtual plane are arranged side by side in the lateral direction of the second rectangle and such that the points in a row and the points in an adjacent row in the lateral direction are shifted from each other in the longitudinal direction of the second rectangle, in the first aspect. This aspect allows it easier to suppress unevenness in the longitudinal direction in the water flow distribution of a water flow group sprayed from the water spray part.

In a water spray member according to the third aspect, each of the plurality of shower holes may be formed so as to discharge a single line-like water flow in the first aspect or the second aspect. According to this aspect, even when a water flow group sprayed from the water spray part hits the surface of an object, splashing is less likely to occur, and more favorable user-friendliness can be obtained.

Another aspect of the present invention relates to a water discharge device. A water discharge device according to the fourth aspect comprises a water spray member according to any one of the first to third aspects and a device body to which the water spray member is mounted and in which a water supply channel for supplying water to the water spray member is formed.

In a water discharge device according to the fifth aspect, the water spray member may be mounted rotatably around an axis passing through the front and back of the water spray part with respect to the device body in the fourth aspect. According to this aspect, it is possible to prevent interference of the water spray member and the device body with surrounding objects in rotating the water spray range of the water spray member, and favorable user-friendliness can be obtained.

In a water discharge device according to the sixth aspect, the device body includes a water discharge head to which the water spray member is mounted and a head holder for holding the water discharge head so as to be detachable in one direction, and the water discharge head may be held rotatably around the attachment/detachment direction axis with respect to the head holder in the fourth aspect or the fifth aspect. According to this aspect, by rotating the water spray member together with the water discharge head around the attachment/detachment direction axis, the water spray range of the water spray member can be moved in a sweeping-like manner, and favorable user-friendliness can be obtained.

10 water spray member

12 water discharge device

20 water supply channel

22 device body

28 water spray part

34 shower hole

46 shower hole forming surface

52 first rectangle

56 second rectangle

68 water discharge head

70 head holder

The present invention relates to a water discharge device.

1. A water spray member comprising:
a plate-like water spray part through which a plurality of shower holes penetrate in a thickness direction,
wherein given that:
when a shower hole forming surface on a water spray direction side of the water spray part is viewed in the thickness direction, with regard to a first rectangle with a minimum area whose four sides circumscribe the shower hole forming surface, the respective dimensions of a first longitudinal side and a first lateral side that are adjacent to each other are denoted as a and b, respectively; and
on the assumption of a virtual plane that is perpendicular to the thickness direction on the water spray direction side of the water spray part, with regard to a second rectangle whose four sides circumscribe a group of points at which the respective central axis lines of the plurality of shower holes pass through the virtual plane and that has a second longitudinal side and a second lateral side that are respectively parallel to the first longitudinal side and the first lateral side, the respective dimensions of the second longitudinal side and the second lateral side are denoted as c and d, respectively,
the water spray part is formed such that the following conditions (1) to (3) are satisfied.
a≤b (1)
a/b<c/d (2)
a<c (3)

2. The water spray member according to of claim 1, wherein, on the assumption of a virtual plane that is perpendicular to the thickness direction, the plurality of shower holes are formed such that a plurality of rows of points at which the respective central axis lines of the plurality of shower holes pass through the virtual plane are arranged side by side in a lateral direction of the second rectangle and such that the points in a row and the points in an adjacent row in the lateral direction are shifted from each other in a longitudinal direction of the second rectangle.

3. The water spray member of claim 1, wherein each of the plurality of shower holes is formed so as to discharge a single line-like water flow.

4. A water discharge device comprising:
the water spray member one of claim 1; and
a device body to which the water spray member is mounted and in which a water supply channel for supplying water to the water spray member is formed.

5. The water discharge device of claim 4, wherein the water spray member is mounted rotatably around an axis passing through the front and back of the water spray part with respect to the device body.

6. The water discharge device of claim 4,
wherein the device body includes a water discharge head to which the water spray member is mounted and a head holder for holding the water discharge head so as to be detachable in one direction, and
wherein the water discharge head is held rotatably around the attachment/detachment direction axis with respect to the head holder.

7. The water spray member of claim 2, wherein each of the plurality of shower holes is formed so as to discharge a single line-like water flow.

8. A water discharge device comprising:
the water spray member of claim 2; and
a device body to which the water spray member is mounted and in which a water supply channel for supplying water to the water spray member is formed.

9. A water discharge device comprising:
the water spray member of claim 3; and
a device body to which the water spray member is mounted and in which a water supply channel for supplying water to the water spray member is formed.

10. The water discharge device of claim 8, wherein the water spray member is mounted rotatably around an axis passing through the front and back of the water spray part with respect to the device body.

11. The water discharge device of claim 9, wherein the water spray member is mounted rotatably around an axis passing through the front and back of the water spray part with respect to the device body.

12. The water discharge device of claim 8, wherein the device body includes a water discharge head to which the water spray member is mounted and a head holder for holding the water discharge head so as to be detachable in one direction, and
wherein the water discharge head is held rotatably around the attachment/detachment direction axis with respect to the head holder.

13. The water discharge device of claim 9,
wherein the device body includes a water discharge head to which the water spray member is mounted and a head holder for holding the water discharge head so as to be detachable in one direction, and
wherein the water discharge head is held rotatably around the attachment/detachment direction axis with respect to the head holder.

14. The water discharge device of claim 5,
wherein the device body includes a water discharge head to which the water spray member is mounted and a head holder for holding the water discharge head so as to be detachable in one direction, and
wherein the water discharge head is held rotatably around the attachment/detachment direction axis with respect to the head holder.
